(19) United States
(12) Patent Application Publication
(10) Pub. No.: US 2011/0061002 A1
(43) Pub. Date: Mar. 10, 2011

(54) SYSTEM AND METHOD FOR SENDING VARIOUS APPLICATION PROGRAMMING INTERFACES TO A CUSTOMIZED USER INTERFACE

(76) Inventors: David BETHUNE, Palm Springs, CA (US); Christopher L. Russell, Twain Harte, CA (US)

(21) Appl. No.: 12/853,785

(22) Filed: Aug. 10, 2010

Related U.S. Application Data
(60) Provisional application No. 61/236,728, filed on Aug. 25, 2009.

(51) Int. Cl. G06F 3/01

(52) U.S. Cl. 715/744

(57) ABSTRACT

A system and method of providing a customized user interface (UI) on a client, comprising: receiving a chosen API or a default API; receiving any user identity information; retrieving any local data; retrieving any query result from any user input information; and creating the customized UI in XML for any chosen APIs based on any user identity information, any query result information, and any local data.

### CROSS-REFERENCE TO RELATED APPLICATIONS

This application claims priority to U.S. Provisional Application No. 61/236,728, filed Aug. 25, 2009. The entirety of the aforementioned application is incorporated herein by reference.

### SUMMARY OF THE INVENTION

The present disclosure discusses conveying the output of at least one arbitrary application programming interface (API) to a customized user interface, coincident with and dependent upon the user's identity and the user's inputs.

### BRIEF DESCRIPTION OF THE DRAWINGS

FIGS. 1 and 2 show a system for sending various application programming interfaces to a customized user interface according to one embodiment;

FIGS. 3 and 4 show flow charts depicting methods for sending APIs to a customized user interface according to multiple embodiments;

FIG. 5 illustrates a list of codex entries and widgets according to one embodiment;

FIG. 6 illustrates examples of IL requests and IL results according to one embodiment;

FIG. 7 illustrates example of triggers cause by codex and widgets according to one embodiment;

FIG. 8 illustrates how IL results may be displayed according to one embodiment.

### DETAILED DESCRIPTION

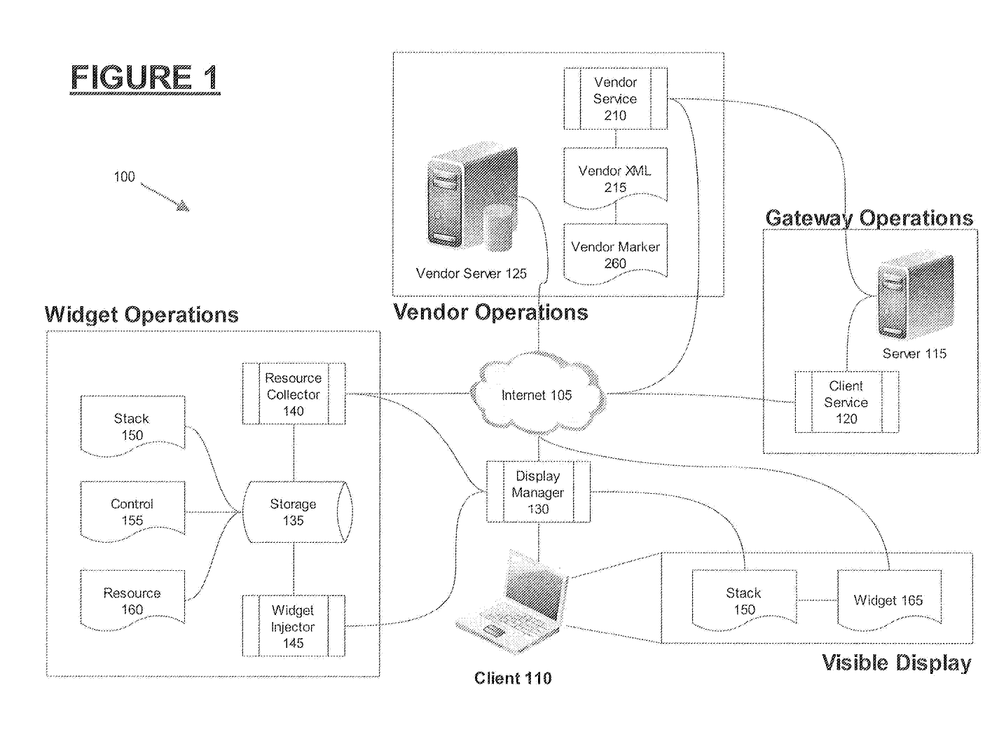

FIG. 1 illustrates a system 100 for sending various application programming interfaces to a customized user interface, according to one embodiment. As described below, data can be extracted from APIs and local data sources and assembled into a user interface. The user interface can thus be created on-the-fly to better represent the kind of data the user is working with. This user interface can employ data from several sources, both local and remote sources, even competing data providers. A user can also exercise a great deal of control over which data is used to create the display and also what interface conventions and devices are used to present the display. The system 100 can include at least one client 110 (e.g., at least one desktop client, at least one browser client, and/or at least one mobile client) connected to at least one server 115 through at least one network 105 (e.g., the Internet). At least one client service 120 can also be connected to at least one client 110 and at least one server 115 through the at least one network 105.

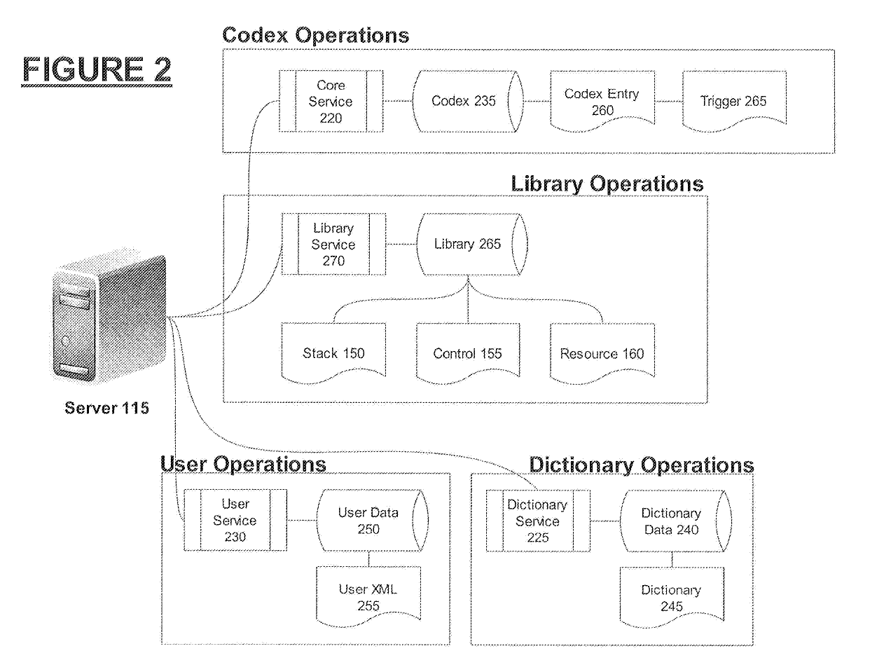

The server 115 can communicate with clients 110 via client service 120 and with vendor servers 125 via vendor service 210. The server 115 can also manage dictionaries 245 (explained in more detail in FIG. 2), controls 155, resources 160, and users. The client service 120 running on the server 115 can conduct all communication with the clients 110.

The client service 120 makes it possible for local data along with results from application programming interfaces (APIs) from multiple vendor servers 125 to be presented to at least one user on at least one customized user interface on the client 110. Possible vendors include, but are not limited to at least one encyclopedia vendor (e.g., Wikipedia, Freebase), at least one picture vendor (e.g., Flickr, Google Images), at least one search vendor (e.g., Google, Yahoo), at least one social networking vendor (e.g., Facebook, Twitter), or at least one map vendor (e.g., Google Maps, World Wind), or any combination thereof.

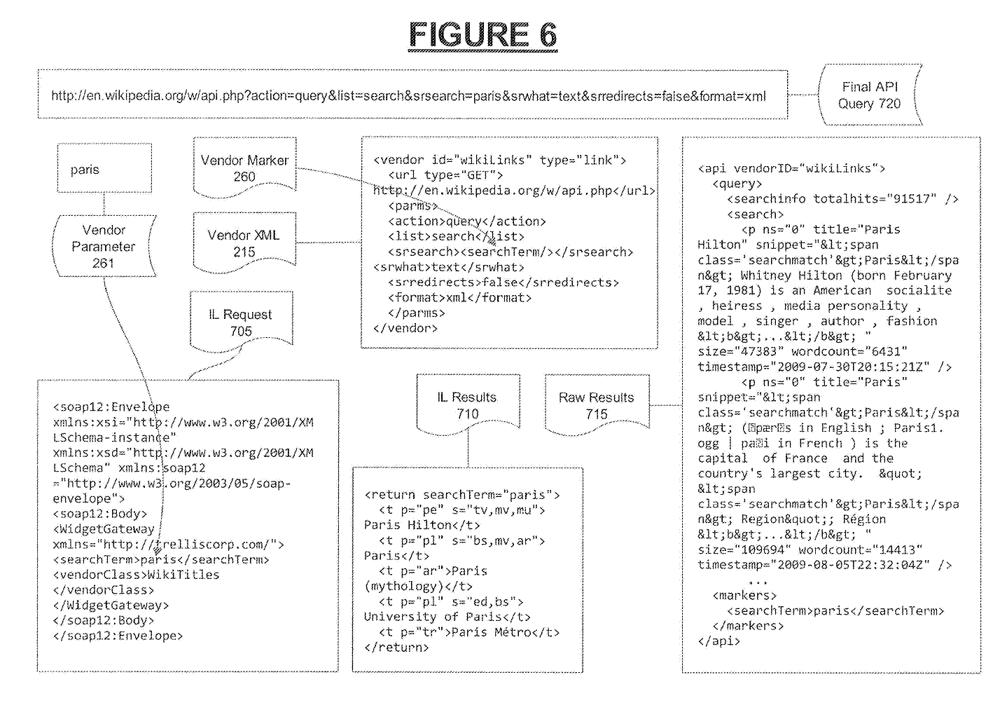

The vendor service 210 can run on the server 115 and can conduct all communication with vendors. The server 115 can communicate with a vendor's API via vendor service 210 using information stored in vendor XML 215, which can describe a vendor's API using XML language. The vendor XML 215 can include vendor markers 260, which are replaced with vendor parameters 261 when building a final API query 720 (explained in more detail in FIG. 6).

The client 110 can include a display manager 130, which can manage how and what is displayed on the client 110. The display manager 130 can access a resource collector 140 and a widget injector 145, utilizing storage 135 in some embodiments. The storage 135 can be isolated and can store stacks 150, controls 155, and resources 160. A stack 150 can be a list of widgets 165, presented in a certain order. A widget 165 can be a user interface component built from a set of resources 160 and controls 155. A resource 160 can be an item of data that can be used by more than one program or in more than one place in a program (e.g., a color, a font, a vector image, a bitmap image, a video, or an audio file). A control 155 can be an object on a screen that can be manipulated by a user to perform an action (e.g., a button, a scroll bar).

In one embodiment, developers and users can choose the kinds of user interfaces that best fit the type of information they are working with. Different types of vendors (e.g., data providers), each with its own proprietary API, can present data together m a unified use interface. The user interface can combine this vendor data with local data stored on the client machine. The user interface can be especially selected for the task at hand, taking into account the user's present and past interactions with the system 100 and method.

Examples of user interfaces that can be created include, but are not limited to, interfaces for cross-platform applications (e.g., HTML5 user interfaces with JavaScript code; Flash or AIR user interfaces with ActionScript code), native applications (e.g., Android applications with Java code; Mac OS applications with Objective-C code; Windows applications with .NET code), or client/server web pages (e.g. Active Server Pages; HTML/CSS), or any combination thereof. Those of ordinary skill in the art will see that many other types of platforms can be used. The user interface can be created in real-time after analyzing the user's identity information and the user's input information. Examples of the user's identity information can include local identity and social networking identity. Examples of the user's input information can include past inputs and present inputs. The display manager 130 can select, assemble, populate, and deploy high-level modular user interface components (e.g., widgets 165) from a set of standard, community, and customized controls 155 to produce and manage interaction within the final user interface that appears to the user.

FIG. 2 illustrates additional details of a client service 120 for sending various application programming interfaces to a customized user interface, according to one embodiment. The client service 120 can include at least one core service 220, at least one codex 235, at least one codex entry 260, at least one trigger 265, at least one library service 270, at least one library 265, at least one user service 230, user data 250, user XML 255, at least one dictionary service 225, dictionary data 240, and at least one dictionary 245.

The core service 220 can run on the server 115 and can provide access to the codex 235 The core service 220 can also turn raw results from vendors into an XML interface language. The codex 235 can reside on the server 115 or reside on another remote computer. The codex 235 can define codex entries (which also define stacks 150, which can have a list of widgets 165) using an XML language. The codex entries 260 can be sorted in the codex and can contain triggers 265 for one type of vendor data returned by a vendor's API. Triggers 265 can be text to be matched with text in a vendor's API results.

The library service 270 can run on the server 115, and can retrieve stacks 150, resources 160, and controls 155 from a library 265. The library can also reside on the server 115 (or another remote server). The library 265 can access stacks 150, controls 155 and/or resources 160.

The user service 230 can run on the server 115, can authenticate users, can get user XML 255 from user data 250 and can save changes there. The user data 250 can reside on the server 115 or another remote computer. The user data 250 can be a repository of user XML 255 information and can be stored in a database or as an XML flat file. The user XML 255 can store information about the preferences and behaviors of users in the user data 250. It can only be accessed, in some embodiments, by the user service 230.

The dictionary 245 describes search terms using an XML language and can reside in the dictionary data 240. The dictionary data 240 can reside on the server 115 or another remote computer, and can be a repository of dictionaries 245. The dictionary data 240 can be stored in a database or as XML flat files. The dictionary service 225 can run on the server 115 and can retrieve dictionaries 245 from the dictionary data 240. The dictionary service 225 can also store changes to dictionaries 245 in dictionary data 240.

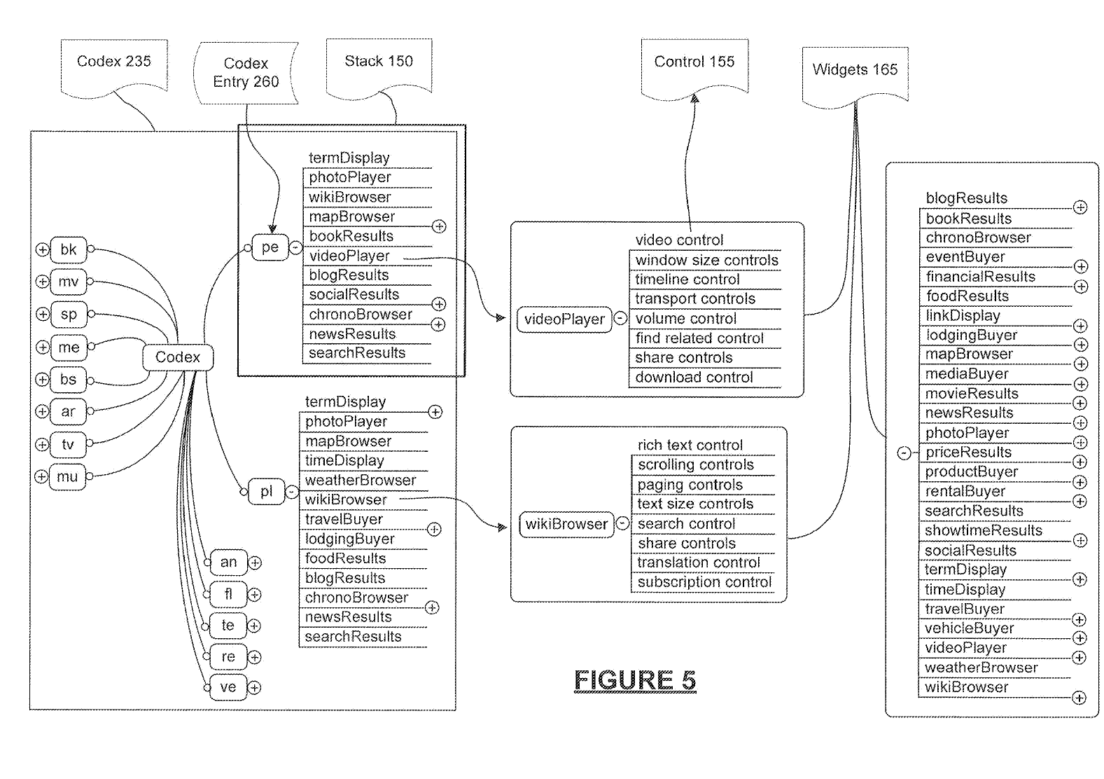

FIG. 5 illustrates a list of codex entries 260 for a particular application. For example, “pe” stack 150 can list all of the widgets 165 to be displayed for a person (e.g., Paris Hilton); “pI” stack 150 can list all the widgets 165 to display for a place (e.g., Paris, France). it should be noted that the codex entries 260 can change based on the application being used, and that multiple applications with different codex entries 260 can be used. For example, in a travel application, the codex entries might be different stacks 150 for air, cruise, hotel, and package travel. In an insurance application, the codex entries 260 may be different stacks 150 for car, boat, motorcycle, and homeowners insurance. Any request from the user can be displayed in a stack 150.

FIG. 5 also displays a generalized list of widgets 165, which can illustrate widgets that can be utilized. These widgets 165 can be high-level modular components comprised of controls 155 which can be reused in different stacks 150 and also redecorated by different resources 160. These widgets 165 can contain data binding, so that, when the data arrives in XML language form (IL results 710) from the server 115, the data can appear in the correct place in the final customized user interface. FIG. 5 also illustrates two widgets 165 the videoPlayer widget and the wikiBrowser widget) that have been expanded to show the controls they contain.

The display manager 130 can present an aggregate user interface which is assembled in real time from modular components stored on the user's computer. A user may, through his interactions with the user interface, indicate that he wishes to access certain local data or receive information from one or more vendors who make remote data available via an API, such as an online encyclopedia, a search engine, a media database, or a social networking service. The client 110 can then generate a request to a server 115 using an XML Interlace language. The server 115 can translate the request into the specific query demanded by the vendor's application programming interface, including any parameters from the user. The server 115 can also translate the vendor's results back into interface language before returning the data to the user. Through binding, the data from the vendor can be inserted into the modular user interface components, causing the user interface to display the vendor's data in a user interface that was generated by the display manager 130. Local data, stored on the client 110 or calculated in real time, can also be bound to the widgets 165. A user's past behavior and preferences can be stored and can also be considered when choosing and decorating the modular interface elements.

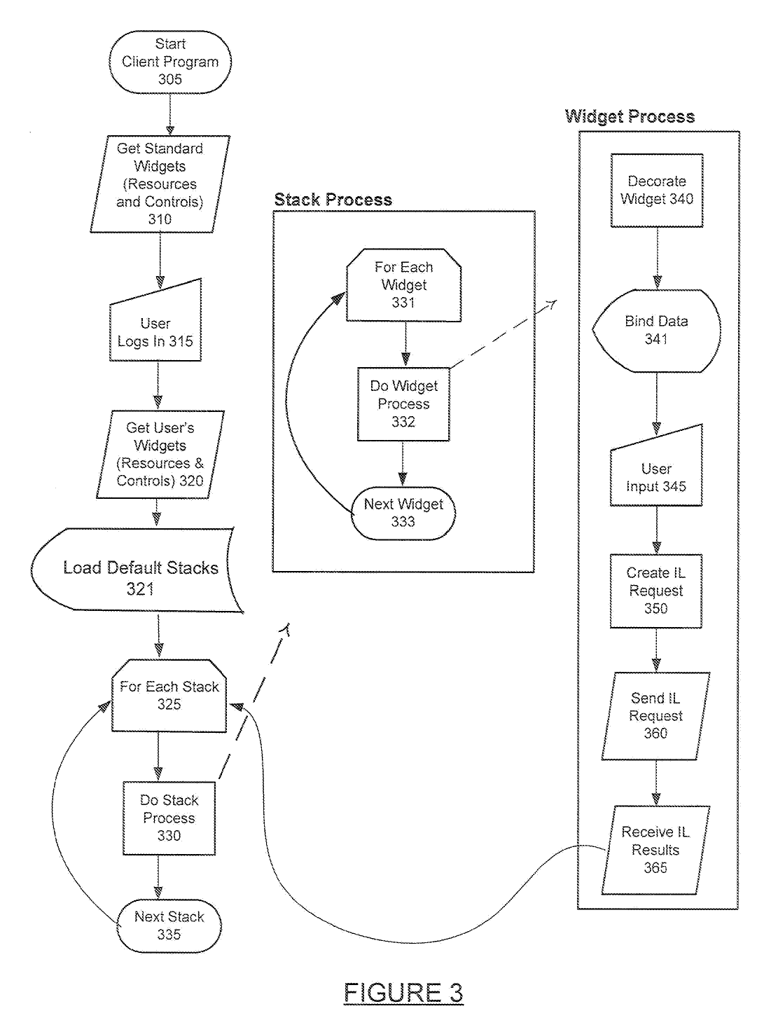

FIG. 3 illustrates a method (from a client 110 perspective) of sending various APIs to a customized user interface, according to one embodiment. In 305, the user starts the display manager 120, which accesses the client service 120. In 310, the resource collector 140 begins to download a default set of widgets 165 (e.g., controls 155 and resources 160) if any are missing from storage 135. The downloaded widgets 165 can be used to present to the user a default customized user interface. The widgets 165 can also be used to present information from various vendor APIs and from local data stored on the client 110, as needed. For example, a widget 165 can present a song or information about music from a music vendor such as Yahoo Music or Gracenote; a photo from a picture vendor such as Flickr or Google Images; a video from a video vendor such as YouTube or Ustream an encyclopedia entry from an encyclopedia vendor such as Wikipedia or Freebase; a blog post from a blog vendor such as WordPress or TypePad; a stock quote from a financial vendor such as Xignite or StrikeIron; a social networking profile from a social networking vendor such as Facebook or Twitter; and/or a map from a map vendor such as Google Maps or World Wind. A widget 165 can also combine vendor data and local data, stored on the client 100. For example, a widget 165 can combine bank account balance information from a financial services vendor such as Mint.com or accounting software data from a cloud services vendor such as intuit, with local data about a retail store's transactions stored on the client 110, to create a user interface for a point of sale system.

It should be noted that the controls 155 can be user interface components written in the native platform the client 110 is running, or in any combination of native and cross-platform user interface technologies which client 110 is capable of running. For example, a Flash or Adobe AIR client 110 could be made with a combination of MXML controls 155 and ActionScript code. As another example, a native Mac OS, iPhone, or iPad client 110 could be made with Cocoa controls 155 and Objective-C code. As a further example, a Windows application could be made with WPF or Silverlight controls 155 and .NET code. The controls 155 and resources 160 can together comprise high-level modular user interface elements that can obtain relevant data and display it in a certain format (e.g., the appearance desired by the application designer or the user). The resource information can allow the customized user interface to display pictures, logos, and/or color palettes in a certain stack order. For example, modular elements of rich interface data comprised of graphics, colors, pictures, fonts, and code can be downloaded. Note that, in one embodiment, this rich interface data can be written in advance by developers and downloaded to the client in 310 so that the rich interface data is ready to be used in interface-building when basic vendor data is received from the server 115. Thus, when the vendor data is received over the network 105 in standard XML form, a custom user interface can be built on-the-fly at the client 110 using the rich interface data selected after the search is done, and then decorated to match the user's needs and circumstances. In one embodiment, multiple vendor interactions may be needed to determine how to build the customized user interface.

With respect to the resources 160 that will be necessary to display all of the possible desired widgets 165, it should be noted that in one embodiment the widgets 165 car contain references to colors, logos, and bitmap images based on the role that each plays in the design of the widget 165. For example, a widget 165 might contain a named reference to a background color or button color, rather than the hexadecimal representation that color. The application designer for the widget 165 might design several palettes of colors which work well together, choosing a specific color for a background color and a different, contrasting shade for a button. The application designer might also specify that a particular vector or bitmap graphic should be displayed as part of the design to include, for example, a logo or a specific button design.

It should be noted that a stack order can he the order in which to display a list of widgets 165. For example, if the stack 150 for a music artist is: 1) photo player, 2) wiki entry, and 3) music player; then photos would come first in a control 155 for viewing photos, then some biographical text from the artist's Wikipedia entry in a control 155 for browsing wiki text, and then a list of songs for the artist in a control 155 for playing music. To accomplish this, the stack 150 would be defined to include a photo player widget 165, a wiki browser widget 165, and a music player widget 165. The pictures, logos, and color palettes, and the order of widgets 165 on the stack 150 can be customized to different users based on the user's identity information, on the user's previous inputs (e.g., repeated searches for “France”), or on user-set preferences. For example, a user could change the definition of the stack 150 on their particular machine. In one embodiment, the client service 120 obtains the data, but the customization takes place on the client 110. In other embodiments, the customization can take place on the server 115 or on a combination of the client 110 and the server 115.

In 315, the user optionally logs in. In 320, the resource collector 140 loads additional widgets 165 (e.g., resources 160 and controls 155) from the server 115 if any are specified by user-set preferences and are not already present in storage 135. A user can customize user preferences in several ways. For example, a user could choose a different widget 165 from a list of widgets 165 available on server 115. Or a user could add a new widget 165. For example, if a user prefers a different photo player widget 165 than the one generally used in building the customized UIs, this user preference would be consulted, and the photo player widget 165 preferred by the user would be employed in any stack 150 containing a photo player widget 165, regardless of the vendor or API that generated the photos. A user could also customize user preferences by redecorating one or more widget(s) 165 using different resources 160. For example, different color palettes and different sets of vector and bitmap images could be designated by the user. In this manner, predefined resources 160, complete sets of harmonizing colors, vector graphics, and bitmaps, can be selected and those preferences stored and applied when building the stack 150.

In 325, for each stack 150 of widgets 165, the display manager 130 can build the stack 150 in 330. This can be done by taking each widget 165 in 331, performing the widget process in 332, and then moving on to the next widget 165 in the stack 150 in 333. Performing the widget process 332 can comprise: decorating the widget 165 in 340, binding the data in 341, receiving user input in 345, creating the IL request 705 in 350, sending the IL request 705 in 360, and receiving the IL results 710 in 365.

Decorating the widget 165 in 340 can comprise decorating the underlying control 155 using the resources 160. Binding the data in 341 can comprise inserting vendor data from the interface language results (IL results 710) and local data from the client 110 into an underlying control 155. Receiving the user input in 345 can comprise receiving input that needs to go to a vendor API. For example, if a user types in “paris” in the default interface, the client service 120 can communicate this with the server 115. If the vendor parameter 261 is “paris”, “paris” can be submitted to multiple vendors as part of sending the IL request 705 in 360, and the results from the various APIs can be received as part of receiving the IL results 710 in 365. The vendor XML 215 can then be translated into the final API query 720. This translation can be done using vendor markers 260 (pan of vendor XML 215), so a search can quickly and automatically be done with all relevant APIs using the same input parameter(s).

For example, when an initial search term “paris” is entered into a search box widget, the client service 120 can return five results marked for five different stacks 150 (e.g., one stack 150 for Paris Hilton, one for Paris, France; etc.). These five stacks 150 can be decorated and added to the user interface. For example, one stack 150 could be about Paris Hilton and contain a song player which offers to play five of Paris's songs. A click on a song could initiate communication with the server 115 in order to get more information from different vendor APIs, such as a bitmap image of the album cover, a list of related songs, a video, or the streaming URL for the song itself. These could be returned as interface language results (IL results 710) which could be bound to the widgets 165 already on the screen or added as one or more new widgets 165 by the widget injector 145 where appropriate. Local data about Paris Hilton, such as which songs were the user's favorites, could also be bound to the widgets 165. Incoming data could also cause existing widgets 165 to be removed from the screen, reorganized, or redecorated.

The client 110 can utilize the user preferences or any other local data stored on client 110 and can create an interface language request (IL request 705) for each widget 165 with vendor IDs and their corresponding vendor parameters 261. The client 110 can also add each widget 165 to the final customized user interface that the user sees. If an IL request 705 is present in a widget 165, the client 110 can send the request to the server 115 (e.g., the search box widget indicates it needs to get results for “paris”). For each API, the vendor language describing their application and where the vendor parameters 261 are may need to be written in vendor XML 215. After each widget 165 is added to the display, it can communicate independently with the server 115 by sending its IL request 705 (e.g., the search box widget might send a request for data from several encyclopedia vendors such as Wikipedia and Freebase along with a request for search engine data from Google or Bing and a request for photo data from Flickr or Google Images, or lacking any vendor specification in the IL request 705, the server 115 might choose these as the default vendors). As each IL result 710 comes back from the server 115, the display manager 130 routes it to the widget 165 that made the original IL request 705 (e.g., all of the results for “paris” from all the requested vendor APIs are made available to the search box widget in a uniform XML form, the IL result 710). The widget 165 can also communicate directly with local data sources on client 110 or perform calculations involving both local data and data found in the IL result 710. The widget 165 can insert vendor data from the IL result 710, local data from client 110, or the result of a calculation using local data, or IL results 710, or both of these, into one or more of its underlying controls 155 using data binding. For example, the encyclopedia vendor's result for the name of a place, the literal text “Paris, France” can be bound up with text in a text control 155 that is part of a widget 165, so that the words “Paris, France” appear in the location and style specified by text control 155 with the colors specified by the selected resources 160 for the stack 150 in which the widget 165 appears. A photograph of the Eiffel Tower may be selected from a list of photos returned by the photo vendor and its URL can be bound up with an image control 155 at the top of the same widget 165, so that the photograph appears underneath the headline, as in a newspaper. The longitude and latitude information from the encyclopedia vendor can be bound up with a map widget 165 which can be part of the same stack 150. The map widget 165 can in turn contain its own request for a map image from a map vendor. That request can be fired after the map widget 165 is added to the display, so that the map image appears in the display as soon as it comes back from the map vendor without holding up the display of the rest of the stack 150.

It should be noted that triggers 265 in the IL results 710 from each vendor can determine that there are multiple types of results. For example, one search result for “paris” is Paris Hilton and another result for “paris” is Paris, France. The core service 220 can mark the IL results 710 for Paris Hilton with a stack ID 810 to indicate that the client 110 should use a “person” stack 150 to display this data. In one embodiment, only the XML data is going over the network 105 (the actual UI is not going over the network 105), and thus the amount of data is much lower, increasing speed, decreasing cost, making the data less prone to errors, and increasing flexibility (because the UI can be remodeled or changed on-the-fly, even after the data is received at the client 110). The stack 150 is comprised of UI elements (widgets 165). The widgets 165, which were downloaded in 310 and 320, can then be assembled and decorated on the client and bound with the received XML data, with local data from client 110, or with results of any procedure that takes the local data or received XML data as inputs. In the case above where multiple types of results are to be displayed, the data related to one type of result (e.g., Paris, France the location) can be marked with a stack ID 810 designating a stack 150 for displaying data about places, so that data would appear on the UI with location specific controls 155 (e.g., a map) and different resources 160 (e.g., colors, logos, buttons). The data related to a different type of results (e.g., Paris Hilton) could be displayed on the UI using a stack 150 designated for displaying data about persons.

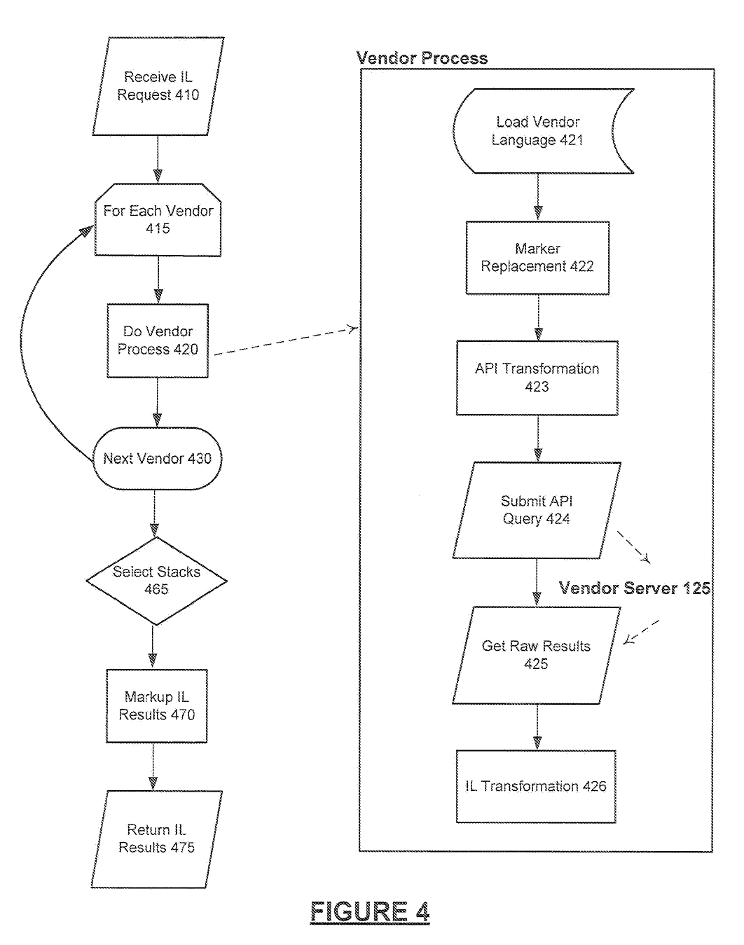

FIG. 4 illustrates a method (from the server 115 perspective) of sending various APIs to a customized user interface, according to one embodiment. In 410, the server 115 receives an IL request 705 from the client service 120 (e.g., a request for Google and Flickr or a default request not specifying any particular vendor). In 415-430, for each vendor specified in the IL request 705 (or each default vendor), the server 115 does the corresponding vendor process.

The vendor process in 420 can comprise steps 421-426. In 421, the vendor XML 215 can be loaded by the vendor service 210. Then in 422, marker replacement can be done, and the core service 220 can replace each vendor marker 260 found in the vendor XML 215 with the corresponding vendor parameter 261 from the IL request 705 (e.g., a search for “paris” might result in the data “<q><searchTerm/></q>”, being replaced with “<q>paris</q>” in the vendor XML 215). In one embodiment, just the search term can be submitted. In other embodiments, additional parameters can be added. For example, if various APIs are to be sent to a customized user interface in a stack 150, certain vendors could be called (e.g., Wikipedia and Flickr) regardless of the search. If the resulting information indicated (e.g., via triggers 265) that a physical place on the globe is one possible result (e.g., Paris, France), then another vendor's API might be called as well, such as Google Maps. For some vendors (e.g., Wikipedia and Flickr), the search term could be entered without any change. Thus, the search term “paris” could he searched for material on Wikipedia and Flickr. Additional vendors and/or local data could then be scanned to find out more about the requested material. These additional data sources may need to have certain parameters entered. Google Maps, for example, would need to be passed a longitude and latitude in order to draw a map centered on a particular location. This information could be extracted from Wikipedia, then passed to Google Maps in the proper form. The results could be displayed in the customized user interface in different sections on the screen so that the material is organized (e.g., everything about Paris Hilton is displayed in one section as a stack 150, and everything about Paris, France is displayed in a second section as a stack 150). Depending on the widgets 165 comprising the stack 150 used, the user could initiate further communications with different vendor APIs. For example, when interacting with a stack 150 about music, a music player widget 165 could obtain additional information about the artist from Yahoo Music. The vendor service 210 (which can have user preferences entered or changed by the user or an administrator or a client) can also decide which vendors to search, as set by an administrator or developer. These might be overridden by a different choice of vendors specified in the IL request 705, selected by the display manager 130 or perhaps by the user. For example, a search for “insurance quote” could have a stack 150 consisting of a map widget, a quote widget, and a picture widget with photos of cars. The stack 150 could designate which vendor APIs should be used to obtain data for the maps, the quotes, and the pictures of cars. The vendor service 210 could designate that for a certain stack 150, everyone who has a motorcycle should see Travelers before GEICO because Travelers has paid to be first, or perhaps because employees or customers of Travelers are the ones using the client 110. The vendor service 210 could also designate that certain information is displayed in a certain order, or not displayed at all, according to information on which user performed the search. The insurance stack 150 could also contain bindings for local data, such as information about the user's vehicles or notes taken during a phone call with a representative, and this data could appear together with the data received from the vendor service 210.

In 423, the server 115 can transform the vendor XML 215 into the appropriate form for the vendor's own API, the final API query 720 (e.g., for the vendor Google's search results, vendor XML 215 specifies that the API's URL is “ajax.googleapis.com/ajax/services/search/web” and that two parameters, “v” and “q” must be supplied. The search parameter needs to be formatted as “q=paris”, so this is used as the vendor parameter 261). For example, The final API query 720, consisting of the entire HTTP GET request “ajax.googleapis.com/ajax/services/search/web?v=1.0&q=paris” could be generated, which points to Google's search server, is in their proper form for API requests, and contains the vendor parameter 261 “paris” from the user.

In 424, the final API query 720 can be submitted to the vendor server 125.

In 425, the vendor service 210 can receive the raw results 715 from the vendor API. These may be in JSON, SOAP, or another type of markup. In 426, the IL transformation can take place. The core service 120 can turn the raw results 715 into uniform interface language, IL results 710, regardless of the vendor's original data structure in raw results 715.

In 465, after the vendor process has been done for each vendor, the stacks 150 can be selected. The server 115 can mark the IL results 710 with the desired stack ID 810. For example, one set of results from an encyclopedia vendor may contain a trigger 265, such as the literal text “cat/location” which indicates data about a place on map. From this, the core service 220 may use an algorithm to decide that a particular stack 150 of widgets 165 designed for geographic places is the best choice for this data.

In 470, the core service 220 can mark up the interface language (IL) results to indicate which stack 150 of user interface widgets 165 would be best to use in displaying this data. For example, when a “place” stack 150 is selected by the algorithm, the literal text “pI” might be used as a stack ID to indicate it that this data should be displayed with a user interface for places.

In 475, the server 115 can send the IL results 710 back to the client service 120 (e.g., part of the uniform XML result for Paris, France could be “<term><name>Paris, France</name><cat>pI</cat></term>”).

FIG. 6 illustrates examples of IL requests 705 and IL results 710, as they move through the system 100, according to one embodiment. in the IL request 705, the following can be seen: the user's entered search term “paris” and the corresponding vendor parameter 261 (e.g., <searchTerm>paris<searchTerm>). In the vendor XML 215, vendor marker 260, shown as <searchTerm/> will be replaced with the vendor parameter 261 “paris” when doing marker replacement 422. When performing API transformation 423, the client service 120 generates the final API query 720. In this final API query 720, the HTTP GET request containing the search parameter in the vendor's API format (e.g., “srsearch=paris”) can be seen. The final API query 720 also contains other parameters necessary to complete a call to the vendor's API. The vendor server 125 can return raw results 715, which here are shown in Wikipedia's proprietary XML format. After IL transformation 426 and, optionally, repeating the process with one or more additional vendors, a final set of IL results 710 can be produced, shown in this example with Paris Hilton identified primarily as a person (p=“pe”) involved in TV, movies, and music (s=“tv, mv, mu”) while Paris is a place on a map (p=“pI”) and also a center for business, movies, and art (s=“bs, mv, ar”).

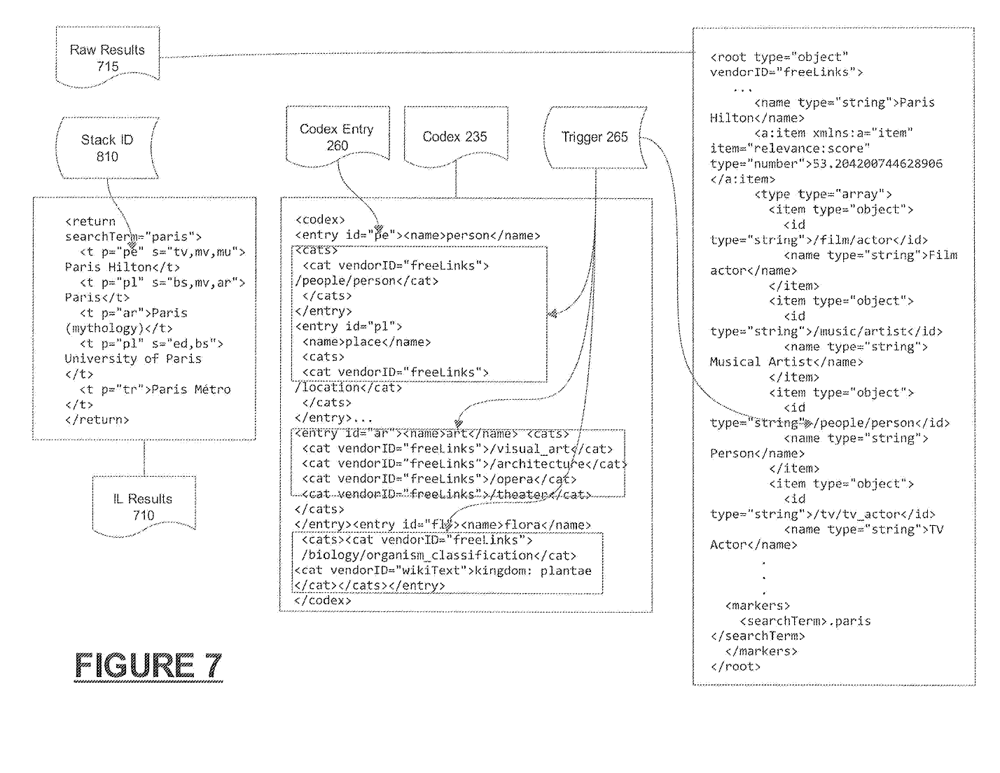

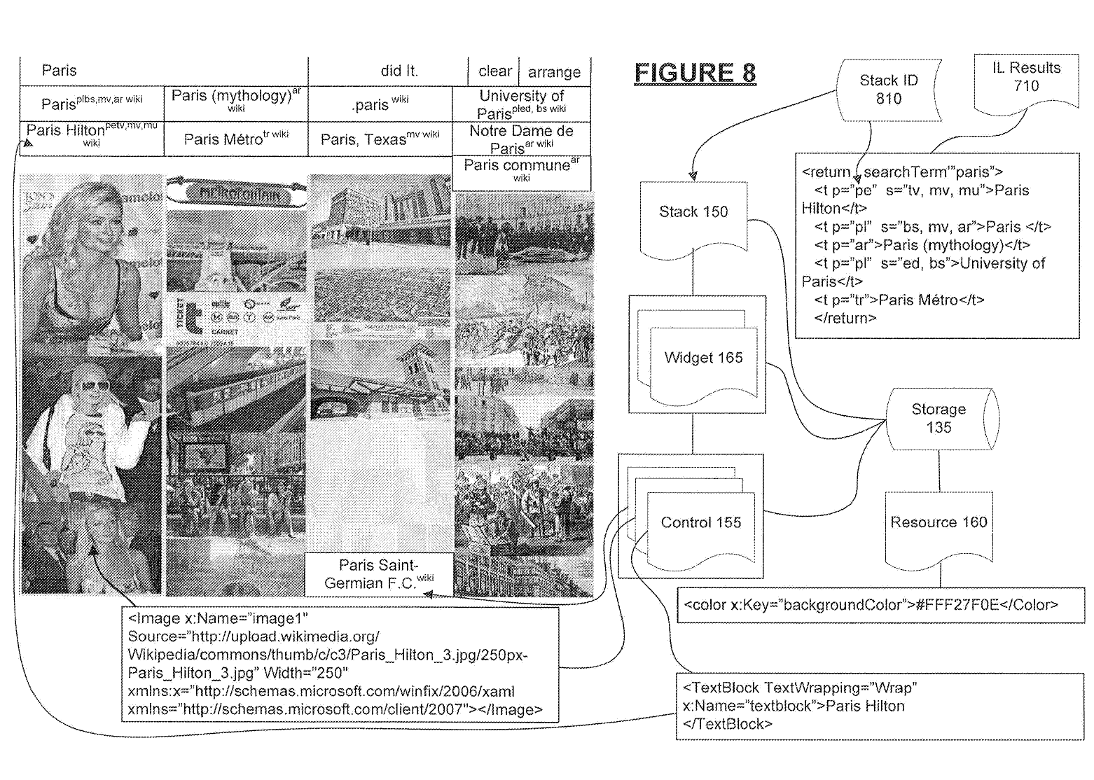

FIG. 7 illustrates example of triggers 265, according to one embodiment. When raw results 715, which can come back from a vendor server 125, are found to contain a trigger 265 from the codex 235, the stack ID 810 of the corresponding codex entry 260 can be added to IL results 815. In codex 235, numerous data items from a single vendor (e.g., shown as vendorID=“freeLinks”) can be used to select among several types of stacks 150, shown in FIG. 8 with the trigger 265 “/people/person” which equates to stack ID 810 “pe” and the trigger 265 “/location” which equates to stack LD 810 “pI”.

Codex 235 illustrates several different ways triggers 265 can be used. For example, triggers “/people/person” and “/location” are from the same vendor, Freebase (“freeLinks”), and indicate two different stack IDs 810 (“pe” vs. “pI”). Text from Freebase containing “/people/person” could be marked with stack ID 810 “pe” for the stack 150 designed for persons and text containing “/location” could be marked with the stack 810 “pI” for the stack 150 designed for places. Codex 235 also illustrates additional triggers 265 (“/visual_art”, “/architecture”, “/opera”, “/theater”), which can be used to indicate the same stack ID 810, (“ar”). Text from Freebase containing any of these strings could be marked with the stack ID 810 “ar” indicating the stack 150 designed for the arts. Additional triggers 265 “/biology/organism_classification” and “kingdom: plantae” from two different vendors (Freebase and Wikipedia, shown as “freeLinks” and “wikiText”) can be used to indicate the same stack ID 810. In this example, data matching the appropriate trigger from either vendor could cause the IL result 710 to be marked with the stack ID 810 “fl” indicating the stack 150 designed for flora.

FIG. 8 illustrates how IL results 710 from various vendor servers 125 can be displayed on the client 110 as stacks 150, according to one embodiment. Each stack 150 can contain one or more widgets 165, which can contain one or more controls 155, which are decorated by resources 160. In this example, the IL results 710 contain a stack ID 810 (shown as p=“pe”) that indicates a particular stack 150 in storage 135. The stack 150 is comprised of widgets 165, such as a term display widget 165 that displays an article title or a photo player widget 165 that displays several photos. Each widget 165 is built from controls 155. These controls 155 can be made of interface markup plus procedural code to handle user interactions. Note that only the user interface markup is shown in this drawing (in this case, XAML markup). Resources 160 in storage 135 can indicate that a particular color (shown here as “#FF27F0E”) should be used to decorate one or more parts of a control's appearance, such as the background color indicated in the diagram. In this way, one or more stacks 150 or widgets 165 might take on a different appearance than others on the screen. The data in IL results 710, which came from the vendor server 125, can be added to the control 155 already on screen when the data is bound, causing the data to appear on the screen.

The embodiments described above can have several practical uses by, for example: at least one search engine, at least one software vendor, at least one social media company, at least one media or publishing company, at least one cloud services vendor, at least one security vendor, at least one broadband service, or at least one broadband hardware provider, or any combination thereof. For example, a search engine could use the technology to offer a rich search engine without jeopardizing their present business. In addition, a software vendor could utilize the technology to add support for widget tooling. Additionally, a social media company could use the technology to give users more control of their user interface, and also accommodate third party APIs in a manner that can still be branded as the social media company. Furthermore, a media or publishing company can allow users to create their own media portals, akin to a modern version of the TV channel or newspaper with a far more sophisticated display and more content choices. Users could choose their own widgets and stacks, and also design new ones, creating their own screen displays and content streams.

As an additional example of a practical use, a cloud services vendor can control the right to build interfaces using the technology in order to support cloud computing services. Widget tooling and education can be offered to encourage application development on cloud services. Data binding can help prevent applications from breaking when cloud services change their APIs. In addition, employing the technology could allow cloud services and network providers to prevent applications from using a competitive computing, payment, or storage service.

Another example of a practical use is a security vendor, which could use the technology to help guarantee security and backup for applications which use it. For example, the server 115 could be hosted under a specific security protocol, so that applications using the technology could be white listed. In addition, backup would be faster with reduced volume. Cache services could aggregate common data across clients and servers, as no user interface or API is present that would dirty up the data and prevent its reuse.

An additional example of a practical use is a broadband service, which could use the technology to optimize and control traffic on a network. Interface language often uses less bandwidth and is easier to inspect, diagnose and modify because it is human-readable and it isolates kinds of information being carried as well as the areas of human knowledge that the information represents. A broadband service might want to cache, modify, or deny certain kinds of traffic, including specific APIs, UIs, or content flowing in either direction. They might also like to brand or advertise specific content, user interfaces, or APIs, and the technology makes it easy to identify and isolate those streams. It can also remove duplicate content. The reduction in content flowing over the network can cut carrier costs and can increase the number of profitable services that can be offered on the same infrastructure. Competitors and security threats can also be prevented.

A further example of a practical use is that by a broadband hardware provider, which might use the technology to help enable a new generation of user interfaces on a wide variety of devices while optimizing traffic for their own equipment at the hardware level. A set top box or broadband appliance can communicate with its host and save bandwidth while increasing flexibility in user interface design. A carrier could also more easily change either their user interface or their content stream without one affecting the other.

Those of ordinary skill in the art will see that the above example uses can be used in many combinations other than the ones described above.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown. For example, the steps listed in any flowchart may be re-ordered or only optionally used in some embodiments.

In addition, it should be understood that many times throughout the disclosure a term is described in the singular (e.g., “a database”). Those of ordinary skill in the art will recognize that a plurality can also be utilized (e.g., one or more databases).

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

In addition, it is the applicant's intent that when any element of the system or method is described as “an”element, it is meant to include “at least one” of that element. For example, if “an” accounting application is described, “at least one” accounting application is also meant to be described.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method of providing at least one customized user interface (UI) on at least one client, comprising:
receiving at least one chosen API or at least one default API;
receiving any user identity information;
retrieving any chosen local data;
retrieving any API query result from any user input information; and
creating the at least one customized UI in XML for the at least one chosen API or the at least one default API based on any user identity information, any API query result, and any local data.

2. The method of claim 1, wherein the retrieving any API query result from any user input information accounts for at least one API that requires query inputs to be in a certain parameter format.

3. The method of claim 1, wherein any received user identity information and/or any retrieved query result information is formatted in XML.

4. The method of claim 1, wherein formatting of the at least one customized UI s done only at the at least one client.

5. The method of claim 4, wherein any received user identity information and any retrieved query result information is sent only as data to the at least one client.

6. The method of claim 1, wherein the at least one customized UI can be customized by the at least one user.

7. The method of claim 6, wherein the at least one user can ask that certain APIs be queried and certain APIs not be queried.

8. The method of claim 1, wherein any local identity information comprises: local identity information and/or social identity information about at least one user.

9. The method of claim 1, wherein any local identity information comprises: at least one user ID; at least one password for at least one API, at least one preference; at least one social identity.

10. The method of claim 9, wherein the at least one social identity is taken from at least one social network API.

11. method of claim 1, wherein any query result information from the user's input information comprises query results from a variety of APIs.

12. The method of claim 1, wherein the at least one customized UI is displayed as a stack of API information.

13. The method of claim 1, wherein the at least one customized UI includes: HTML5 components and JavaScript code; Flash components and ActionScript code; XAML components and .NET code, Cocoa components and Objective-C code; Android components and Java code, or any combination thereof.

14. The method of claim 1, wherein an algorithm selects, assembles, populates, and deploys the data to be presented on the at least one customized UI from at least one library of standard, community, and customized controls.

15. The method of claim 1, wherein the method is utilized by: at least one search engine, at least one software vendor, at least one social media company, at least one media or publishing company, at least one cloud services vendor, at least one security vendor, at least one broadband service, or at least one broadband hardware provider, or any combination thereof.

16. The method of claim 1, wherein information about the kind of data being transmitted and the area of human knowledge it represents is provided.

17. A system of providing at least one customized user interface (UI) on at least one client, comprising:
at least one server and/or at least one client coupled to a network;
at least one application coupled to the at least one server and/or the at least one client, the at least one application configured for:
receiving at least one chosen API or at least one default API;
receiving any user identity information;
retrieving any chosen local data;
retrieving any query result information from any user input information; and
creating the at least one customized UI in XML for the at least one chosen API or the at least one default API based on any user identity information, any query result information, and any local data.

18. The system of claim 17, wherein the retrieving any API query result from any user input information accounts for at least one API that requires query inputs to be in a certain parameter format.

19. The system of claim 17, wherein any received user identity information and/or any retrieved query result information is formatted in XML.

20. The system of claim 17, wherein formatting of the at least one customized UI is done only at the at least one client.

21. The system of claim 17, wherein any received user identity information and any retrieved query result information is sent only as data to the at least one client.

22. The system of claim 17, wherein the at least one customized UI can be customized by the at least one user.

23. The system of claim 22, wherein the at least one user can ask that certain APIs be queried and certain APIs not be queried.

24. The system of claim 17, wherein any local identity information comprises: local identity information and/or social identity information about at least one user.

25. The system of claim 17, wherein any local identity information comprises: at least one user ID; at least one password for at least one API, at least one preference; at least one social identity.

26. The system of claim 25, wherein the at least one social identity is taken from at least one social network API.

27. The system of claim 17, wherein any query result information from the user's input information comprises query results from a variety of APIs.

28. The system of claim 17, wherein the at least one customized UI is displayed as a stack of API information.

29. The system of claim 17, wherein the at least one customized UI includes: HTML5 components and JavaScript code; Flash components and ActionScript code; XAML components and .NET code, Cocoa components and Objective-C code; Android components and Java code, or any combination thereof.

30. The system of claim 17, wherein an algorithm selects, assembles, populates, and deploys the data to be presented on the at least one customized UI from at least one library of standard, community, and customized controls.

31. The system of claim 17, wherein the method is utilized by: at least one search engine, at least one software vendor, at least one social media company, at least one media or publishing company, at least one cloud services vendor, at least one security vendor, at least one broadband service, or at least one broadband hardware provider, or any combination thereof.

32. system of claim 17, wherein information about the kind of data being transmitted and the area of human knowledge it represents is provided.
